(19) United States
(12) Patent Application Publication
(10) Pub. No.: US 2016/0066723 A1
(43) Pub. Date: Mar. 10, 2016

(54) Multi-Purpose Kitchen Utensil

(71) Applicants: Mark Prommel, Brooklyn, NY (US); Marco Perry, Brooklyn, NY (US); Matthew Kalish, Saugerties, NY (US); Pil Ho Chung, Jersey City, NJ (US); Kevin O'Leary, Brooklyn, NY (US)

(72) Inventors: Mark Prommel, Brooklyn, NY (US); Marco Perry, Brooklyn, NY (US); Matthew Kalish, Saugerties, NY (US); Pil Ho Chung, Jersey City, NJ (US); Kevin O'Leary, Brooklyn, NY (US)

(21) Appl. No.: 14/482,417

(22) Filed: Sep. 10, 2014

(51) Int. Cl. A47G 21/06; A47J 43/28; A47G 21/10; A47G 21/04

(52) U.S. Cl. CPC A47G 21/06; A47G 21/04; A47J 43/281; A47G 21/10; A47J 43/288; A47J 43/283

(57) ABSTRACT

A multi-functional kitchen utensil comprising separate, individually functioning components. A spatula component, having a handle and spatula head, and a spoon component, having a separate handle and spoon head. The spatula head is substantially flat from side to side at its distal end with a beveled edge and also comprises a rounded, concave center having one or more drainage slots, forming a spoon configuration. The spatula head also has a serrated edge on one or more edges. The spoon head is substantially spoon-like and has a silicone component secured to the distal tip, the silicon and the rounded component extending from the handle, together, forming an integrated spoon shape. The silicone component has a substantially flat but beveled distal edge. The spoon component is secured to the spatula component at a hinged connecting point at or near the proximal ends of each handle to form a pair of tongs.

### FIELD OF THE INVENTION

The present invention relates to a multi-purpose kitchen utensil or tool, integrating and combining multiple and useful kitchen utensils and gadgets into a single tool for the purpose of reducing the clutter and space required for storing such kitchen tools while also providing an integrated single tool having multiple uses, all for ease of cooking.

### BACKGROUND OF THE INVENTION AND DISCLOSURE

For the preparation of most meals, a cook ordinarily and often requires a number of different kitchen utensils or tools, each of which serves a separate useful function. A cook preparing a meal on a cooktop surface should have close at hand a spatula, a tasting spoon, a slotted/straining spoon, a cutting edge, a pair or tongs, etc. Yet, having them all out near the cooktop surface can result in an accident of, for example, one or more falling to the floor, into the heating surface, or, if not on the surface but in an adjacent drawer, requires some time for the cook to locate and bring the same in to the cooking theater. At the least, having all of the individual utensils nearby results in likely unnecessary clutter during cooking. In addition, individual locating the utensils within a crowded drawer or adjacent to one another if on the cooktop surface area can be frustrating, time consuming and, in any event, having so many individual tools can result in drawer clutter, too. Thus, individual utensils have disadvantages. It is thus an object of the present invention to reduce clutter in a kitchen drawer, to reduce clutter around a cooktop surface and to reduce the individual number of utensils, without sacrificing utility. The present invention provides an integrated new kitchen cooking utensil which has many characteristics for replacing many individual kitchen utensils.

In addition, the many individual utensils often have different handles shapes and feels to them. It is believed desired to provide an integrated kitchen utensil with multiple functions and utility which share a single shape and feel to the handle. The prior art consists of multiple utensils, each having a single or at most dual kitchen/cooking function. This can be burdensome for consumers in the sheer number of tools one must purchase, the space required to store a variety of kitchen gadgets, and the amount of kitchen tools or utensils which must be cleaned upon completion of the preparation of the meal. While individuals who love to cook dream of owning homes with large kitchens, multiple ovens, and endless drawers filled with the finest kitchen utensils and tools, the reality is that many people do not cook in large kitchens and do not have a lot of storage space in their kitchen but, rather, they have a kitchen area of cramped quarters and limited storage room for utensils. For example, many live in small apartments in urban areas and there are tens of thousands of students living in dorms but with access to a small kitchen facility. Buying multiple kitchen utensils or tools can also become pricey, especially taking into account the number of different types of functions required or desired for preparation of a single meal. Thus, again, a multi-functional kitchen utensil that reduces the number of individual utensils seems highly desirable. The present invention solves that considered need.

It is considered desirable to provide a kitchen tool which integrates several functions of individual functions of a plurality of household kitchen gadgets into a single utensil to reduce the number of utensils needed to be purchased, stored, used, and cleaned. The present invention is thus designed to provide a highly space efficient, single multi-purpose kitchen tool or utensil which can replace and serve the function of a plurality of utensils having the same functionality. Preferably the present invention will integrate the function of at least six individual utensils, thereby resulting in the possible reduction in the cramped kitchen of six individual kitchen utensils.

The present invention preferably comprises a hinged-together, two-piece new kitchen utensil or tool combining preferably six kitchen tools into a single device. More specifically, the present inventive utensil or tool preferably combines a solid spoon, a slotted spoon, a spatula, a silicone edged and scraping spatula, a cutting edge, and a set of tongs into a single tool. The utensil comprises two separate elements which are connectable when used as a set of tongs and for other utile functions, but which can be easily and quickly separated for ease of use of the some of the characteristics of one or the other component and/or for placing the same into a dishwasher or for washing.

A first component of the present inventive utensil or tool is preferably provided with a head shaped like a scraping and lifting spatula (useful, for example in the creation of omelets and in lifting the same from a pan) and having a longitudinal extendible, hand gripping handle. For present descriptive purposes this element of the two component device is referred to often as the spatula component. Preferably, the spatula head has radial (the head can have a curved outer edge and tapers to the handle) or longitudinal or even laterally extending slots through the center of the head, for draining of fluid, for example, from the spatula. The center of the spatula head is preferably a slight concave shape so that the spatula serves as a spoon. The slots preferably pass through the curved head. The curvature of the spatula or spoon-shaped head of this first of the components allows the handle to be held and the head to serve as a spatula, as a spoon, and as a straining spoon so that liquid can pass through when a more solid item is lifted, as, for example, when trying to separate a meatball from tomato sauce. The proximal end is the holding handle and the distal end is the spatula head, with slots passing therethrough. The outer and free end of the spatula head, extending in a direction away from the handle, after the curved spoon shape, terminates with a preferably flat end, without substantial curvature to more closely resemble in appearance and function a traditional spatula. Thus, the single spatula head and extending handle can act as both a traditional spatula, a strainer, and a slotted spoon.

Additionally, the outer edge of one or more edges of the spatula component (and/or the other spoon shaped component, also with a handle) carries a serrated edge capable of cutting through food stuff materials and thus serving and acting as a knife, especially useful to determine the degree of preparedness of the food, e.g., pasta. The sharpness and thickness of the serrated edge can be altered on each spatula component so that the edge can act as a butter knife for facilitating putting more butter into a pan or a much sharper paring knife. However, the single spatula component—which comprises one half of the utensil/tool of the present invention—provides the structure and features of an ordinary handle extending to a spatula, a slotted spoon, a cutting tool and one half of a set of gripping tongs.

The second component of the utensil or kitchen tool of the present invention preferably also has a longitudinal handle with the same shape and length as the first component. The useful end of the handle, i.e., the distal working end, comprises a spoon shape with a rubber coated edge for facilitating scraping, moving of food within a pan, for example. The concave spoon shape, of course, can be used just as a spoon. The distal edge of the spoon of the second component is preferably thin and tapers from the center of the concavity of the spoon portion and further comprises a slightly straighter than rounded outer edge. More preferably, this outer edge is coated with silicone. The silicone edge enables the free end of the spoon component to also act as a spatula, for scraping, lifting, pushing, etc. and, yet, this edge, as a consequence of its silicone or other temperature-resistant material, can withstand high temperatures during cooking without absorbing flavors, oil, grease, or odors and, in addition, use and touching of the same to pan surfaces, plates, cooking surfaces, etc. will not scratch. This can be especially important in connection with use of the utensil in non-stick cookware where the surface should not be accidentally scratched.

Preferably, the two components of the present invention are joined together with a spring-like connection. This is largely the consequence of the proximal ends of the handles of the two components being mechanically connected to one another, and capable of separating, too, as desired, and the resiliency of the two components, at or about the connection. The handle of the spoon component and the handle of the spatula component are capable of mechanically being secured together. Preferably, the handle of the spoon component and the handle of the spatula component are secured together slightly above their respective proximal ends at a connecting point. The geometry of the connection is preferably quite simple, basically, each end having a cut out which allows the other component to slide therein to couple the two components together. The site of the slots is slightly ahead (or in the distal direction) from the proximal ends of the handles. The handles can thus be used, ahead of the connection, as tongs. The user merely grips the two outer sides of the handles, pressing them together or towards one another and the foodstuff sought to be gripped or grabbed, say, a hot dog, a piece of bacon, or a chicken cutlet, etc., within the pan, can be easily held. Release of the foodstuff, as desired, is accomplished by pressure release of the handles. The rear of the handles no longer being compressed against one another (or a simple spring could be between those proximal ends) and the resilience of the handles provides an open bias to the utensil allowing for the distance between the spatula end and the spoon end to separate, while the user is still holding the same in his/her hand.

Alternatively, a spring is located adjacent and either toward the useful heads of the handles or just behind the same and within the connecting point or between the two proximal edges of the handles, between the two handles of the spatula component and the spoon component. However, it is also envisioned that the spoon component and the spatula component could be secured to one another at their respective end points, with the spring placed between the two components similar to a conventional pair of tongs. The spring allows the two components to act as a set of tongs which can be forced inwardly towards one another to grasp an item. In their resting configuration, the spring, biasing the useful head ends apart, causes the spoon component and spatula component to be separated apart. When the head ends are pushed together by use of a hand compressing the handles towards one another, hinged by the mechanical connection, an item can be easily grasped, and when the pressure released, the head ends will return to their original open positions, thereby releasing the item held there-between.

Collectively, the utensil of the present invention combines preferably six individual kitchen utensils into a single device, comprised of two interconnecting handles. More specifically, the multi-purpose utensil or tool of the present invention comprises elements of a solid spoon, a slotted spoon, a spatula, a silicone-edged spatula, a cutting tool or knife, and a set of food-grasping tongs. Thus, when cooking, a user can scoop, flip, cut, and grasp food items all with the same utensil. A significant advantage is achieved by the variety of utilities provided by the present invention.

### DESCRIPTION OF PRIOR ART

To the Applicant's knowledge, there is no prior art kitchen utensil which combines the structural features and functionality of a plurality of kitchen tools, comprising a solid spoon, a slotted spoon, a spatula, a silicone coated and edged spatula, a knife-like cutting edge or tool, and a gripping set of tongs. Thus, it is desirable to provide a product which combines the features of all of these utensils into a single product for ease and convenience of use, storage, and cleaning. Furthermore, providing the single utensil with a mechanism for simply coupling the two handles, for ease of use and then uncoupling the two components that form the same, for washing and/or storage is highly advantageous.

There exists in the prior art some kitchen utensils which are multi-functional, for example, a spoon having a cutting edge (like a grapefruit spoon) and there may exist, although Applicant is unaware of the same, other multi-functional kitchen utensils for preparing food, but, there seems to be no simple utensil with the multi-functional purpose as the present invention, formed from two components, each having a handle, which are easily coupled to form a set of tongs and, yet, uncoupled for ease of storage and washing. The present invention provides a device with great versatility and is still inexpensive, easy to manufacture and easy to use. It is highly useful in a kitchen and in food preparation.

### SUMMARY OF THE INVENTION

The present invention relates to a multi-purpose kitchen utensil or tool, combining multiple kitchen tools or gadgets into a single useful, easy to make and to use utensil for the purpose of facilitating food preparation. The two-handled utensil allows each handle and its functioning end to be used separately and yet, when the two handles or components are assembled, quickly and easily, a pair of tongs, another important kitchen implement is provided. The present invention reduces the space required for storing such individual kitchen utensils or tools while also providing an integrated plurality of tools for ease of cooking and manipulation.

The present invention discloses a kitchen utensil comprising a spatula component, comprising a handle and a spatula head, and a spoon component, comprising a similarly shaped (and length) handle and a spoon head. The end of the handle of the spatula component is capable of being mechanically connected to the end of the handle of the spoon component. Together, a tong utensil is provided.

The spatula head is substantially flat but comprises a rounded, concave center having one or more slots therein for drainage and the passage of liquid therethrough. One or more side edges of the spatula head has serrations to allow a user to turn it on its side and use the same as a cutting or knife-like tool. The spoon head is substantially concave, like a serving spoon, and provided with a silicone tip or edge at its distal end. The silicone tip of the spoon component tapers from the spoon concavity and has a substantially flattened outer edge to allow the same to be used as a scraping spatula, too.

The spoon component is secured to the spatula component at a connecting point at or near the proximal or non-working ends of each handle, respectively. Stated differently, the spoon shape is the working end of the spoon component and the slotted spatula is the working end of the spatula component. The spatula component and the spoon component are capable of being mechanically and simply connected to one another, at their non-working ends, to thereby provide a useful set of tongs for cooking. In one embodiment the resiliency of the components at the point of connection serves to outwardly bias the working ends of the components apart. Yet, of course, slight pressure by a user on the handles can overcome that outward bias to cause the working ends towards one another to grip food, as desired. Then, when that pressure is removed, the resiliency of the material of the components, at the location of the joining of the two handles, causes the head or working ends to move apart, releasing the food.

Alternatively, a spring can be located at or adjacent to the mechanical connecting point of the two components and it biases the working ends of the components apart but can be easily overcome by gripping and pressure being applied on the handles towards one another. The spoon component and the spatula component act as a set of tongs.

### BRIEF DESCRIPTION OF THE DRAWINGS

FIG. 1A is a front perspective view of a conventional set of tongs;

FIG. 1B is a front perspective view of a conventional solid spoon;

FIG. 1C is a front perspective view of a conventional spatula;

FIG. 1D is a front perspective view of a conventional drainage spoon;

FIG. 1E is a front perspective view of a conventional spatula made from heat resistive material, preferably silicone; and

FIG. 1F is a front perspective view of a conventional kitchen paring knife.

FIG. 2 is a top and side perspective view of the present invention, a multi-purpose kitchen tool, when assembled for use as a set of tongs;

FIG. 3 is another side perspective view of the multi-purpose kitchen utensil seen in FIG. 2;

FIG. 4 is a rear and top perspective view of the multi-purpose kitchen utensil seen in FIGS. 2 and 3; and

FIG. 5 is an enlarged top and side perspective view of the working ends of the multi-purpose kitchen utensil seen in FIGS. 2, 3 and 4.

### DETAILED DESCRIPTION OF THE DRAWINGS AND THE PREFERRED EMBODIMENT

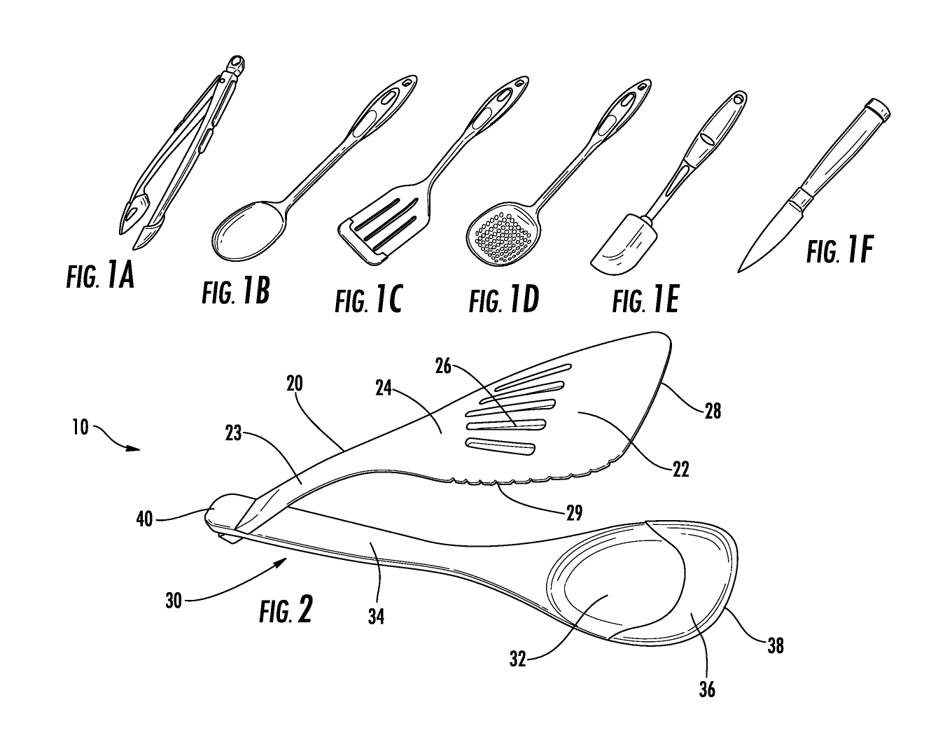

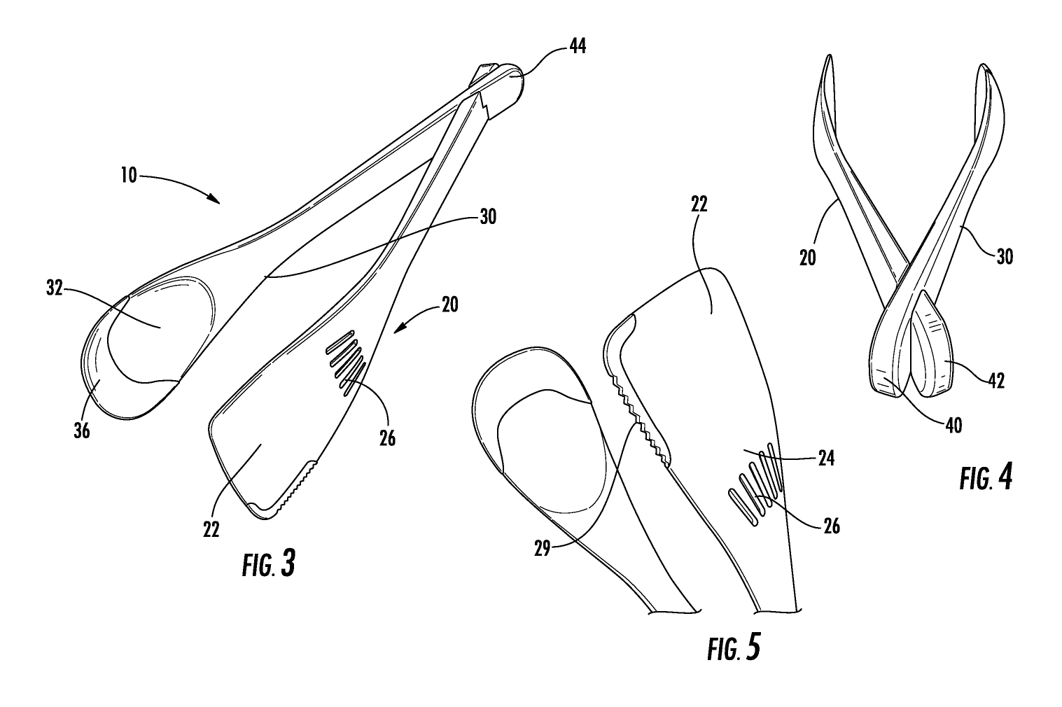

Description will now be given of the invention with reference to the attached FIGS. 1-5. It should be understood that these figures are exemplary in nature and in no way serve to limit the scope of the invention as the invention will be defined by the claims, as interpreted by the Courts in an issued U.S. patent.

FIGS. 1A-F show a set of conventional or traditional individual kitchen utensils or tools, many of which can be replaced by the two-component, fully integrated utensil of the present invention. For example, a pair of tongs is shown in FIG. 1A; a solid spoon shown in FIG. 1B; a slotted spatula is shown in FIG. 1C; and a draining spoon is shown in FIG. 1D. Each is shown with hand grippable, longitudinal handles. A spatula with a dish-washer safe and removable heat resistant working end on a handle is shown in FIG. 1E. FIG. 1F shows a conventional paring utensil useful for cooking and food preparation. The present invention, seen in FIGS. 2-5, preferably presents an integrated, two-component, separable yet capable of assembly for use as a set of tongs, kitchen utensil, having substantially the same use and versatility of the utensils shown in FIGS. 1A through 1F.

The multi-purpose tool 10 of the present invention preferably comprises two components, a spoon component 30 and a spatula component 20. Each is provided with a longitudinal, grippable handle extending rearwardly from the head. For the purposes of this description, the working end is called the distal end and the handle, extending rearwardly, is called the distal end. The handles are comfortably shaped, preferably alike, and preferably, have smooth outside convex-shaped walls for comfort and use.

Spatula component 20 comprises a longitudinal handle 23 extending rearwardly from its working end and, at its distal and working end, a spatula head 22. The tip or end 28 of spatula head 22 is substantially straight, tapered down from the drainage slots 26, to a narrow in relative thickness and flat or slightly beveled edge to ease food manipulation, much as a conventional or traditional spatula utensil. However, the center section 24 of spatula head 22 preferably has a concave curvature to resemble the shape of a spoon and provide similar functionality, and preferably has one or more drainage slots 26 passing therethrough. In the preferred embodiment the drainage slots are longitudinal directed, i.e., in the same basic direction as the extension of the handle, but slightly separating as the slots extend from the narrow part of the working end toward the tip end 28.

Spatula component 20 can thus be used not only as a spatula, for picking up or flipping food items, but also as a spoon for scooping items, and preferably as a slotted spoon for picking up solid items while allowing liquid to pass through the slots 26 at the center section 24. This design is extremely useful as it embodies multiple kitchen utensils integrated into in a single working utensil.

One or more side edges of spatula head 22 preferably comprise a serrated edge 29. Serrated edge 29 allows the spatula component 20 to be turned on it side, moved in the fashion of a knife, either by merely pressing down on the food until the same breaks apart and/or by use of a simple, conventional sawing motion, as one would use the same to cut with a kitchen knife. The sharpness of serrated edge 29 can vary depending on the specific model of the multi-purpose utensil 10, thus allowing the serrated edge 29 to be used for different purposes. For example, serrated edge could have the sharpness of a butter knife for scooping butter from a tub and placing the same into a cooking/sautë pan, or it could be relatively sharp to mimic a paring knife or bread knife. In the preferred embodiment, the entire first, spatula component, including handle, working head, and even the serrated edge are formed from a single molding process and, more preferably, all formed from one synthetic, hard plastic, durable, dishwasher safe material, also having a high heat resistance so that the same can be used in cooking without degradation.

With the serrated edge 29, the spatula component combines the structural features and functionality of several conventional kitchen utensils—a spatula, a slotted, drainage spoon, a spoon, and a knife.

Spoon component 30 comprises a longitudinal handle 34 and a working or spoon head 32 at the distal end thereof. The length, shape and material of the handle 34 of the spoon component 30 is substantially the same as that of the handle 23 of the spatula component 20. The working end of the spoon component at its distal end preferably comprises an inwardly concavity section 32, in the shape of an ordinary spoon. However, the hard plastic spoon portion of the spoon component does not form a complete concave section. Rather, the spoon section of the spoon component is formed partially from the hard plastic material and partially, extending toward the tip end, of silicone. The entire working end of the spoon has a section formed from and extending distally from the longitudinal handle and, attached to the side walls of the concavity portion at the end of the plastic section and to the bottom of the same plastic section is a silicone section, formed, too, into side walls and a bottom, which together, form the concave spoon section and the distal tip. The distal end of spoon component 30 preferably comprises a silicone component 36 which completes the overall concavity or shape of the spoon as the same transitions from the longitudinal handle into a hard plastic concave portion and into the further completing concave portion of silicone. The distal tip 38 of silicone component 36 is preferably beveled, has a slightly straight front edge, and with small curvature on its ends extending into the sides of the spoon portion, so as to enable silicone component 36 to also function as a spatula in addition to functioning as a spoon.

Spoon component 30 and spatula component 20 are preferably mechanically joinable or connected together to form a single integrated kitchen utensil. A multi-purpose tool 10 of the present invention is thus capable of being assembled by connecting the spoon component to the spatula component, at their proximal ends of their respective handles. As can be seen in FIGS. 2, 3 and 4, spoon component 30 and spatula component 20 are preferably joined near end 40 of spoon component 30 and end 42 of spatula component 20. Preferably, ends 40 and 42 have a spring there-between, and more preferably the spring exists internally within connecting point 44 of tool 10. Alternatively, and most preferably, the natural resilience of the plastic material serves as a biasing mechanism to facilitate the closing and opening of the two components, by squeezing the handles together and releasing, respectively, as desired, much in the way one would use a pair or set of tongs. Thus, when the handles of the spatula component 20 and spoon component 30 are forced towards one another by the force of a human hand, the working ends of the spatula and the spoon components can grip food therebetween, just like a pair of tongs. Slight release of the handles, while still holding on to them, by the spring, and/or the resiliency of the proximal ends of the handles, causes the utensil to release the food. Thus, unless overrode by manual force, it is an aspect of the present invention that the working ends be apart. When manual force is applied to the handles to draw them nearer to one another, the spoon head and the spatula head, with its own slight concavity, serve as a food grippable set of tongs.

To connect the spatula component to the spoon component, the slot of one is laterally slid onto the connecting piece of the other and this serves to have the slot of the other receive the connecting bar of the first component. As can be appreciated, the proximal ends of the handles of the components are mirror images of one another. Extending from the proximal ends, 40 and 42 of the spatula component and the spoon component, respectively, is a slot or cut out section, extending across half the width of the handle. Thus, there is a slot or rectangular opening for each handle, extending about ½ the width across the longitudinal handle and a connecting piece, extending across the other half of the handle's width. The dimensioning of the slot is sufficient to receive the thickness of the other handle at the location of its connecting piece and vice versa. Thus, it can be appreciated that the two components can be easily connected and disassembled, as desired. The connecting piece of one, a first component slides into the slot of the other or second component and the slot of the second component accepts or receives the connecting piece of the first component. The two components are thus hingedly secured together with the hinge and point of pivot located at the connecting point 44.

With the handles assembled, the two components, the spatula component 20 and the spoon component 30 can pivot and function as a pair or set of tongs, with food stuff grippable and releasable within the spoon and spatula working ends. The combination of the slots and connecting pieces mechanically allows the two components to be assembled together quickly and easily and just as easily and quickly disassembled for ease of storage and washing.

When the manual pressure on the handles of the spatula component 20 and spoon component 30 are released, the components spring outwardly as a consequence of the natural tendency of the components to spring apart because of the nature of their composition and/or a consequence of an actual spring secured and held between the proximal ends 40 and 42, at a point proximal to the connecting point 44, or a spring located proximal to the connecting point 44. The connection of the spoon component 30 and the spatula component 20 and the outward-pushing force on the same by the spring or springiness of the components is focused at or about connecting point 44 and allows the spoon component 30 and the spatula component 20, together, to act as a set of tongs which, when pushed together, can grasp an item and, when released, will extend outwardly and release the item in its grasp.

Thus, together, these two components form a single, integrated, yet separable as desired multi-purpose kitchen utensil or tool which replace multiple utensils and, yet, provide the versatility and function of many different conventional kitchen utensils. Specifically, the multi-purpose utensil or tool of the present invention preferably comprises the structural features and utility of a solid spoon, a slotted or drainage spoon, a spatula, a silicone-edged spatula, a draining spatula, a cutting knife or tool, and a set of tongs for grasping and releasing a food stuff. The components can be used as separate utensils and can be assembled into a pair of useful tongs. The components can be disassembled for ease of storage and washing.

It will be understood by those of ordinary skill in the art that various changes may be made and equivalents may be substituted for elements without departing from the scope of the invention. In addition, many modifications may be made to adapt a particular feature or material to the teachings of the invention without departing from the scope thereof. Therefore, it is intended that the invention not be limited to the particular embodiments disclosed, but that the invention will include all embodiments falling within the scope of the claims.

What is claimed:

1. A integrated kitchen utensil, comprising:
a spatula component, comprising a first longitudinal and hand grippable handle and a spatula head extending distally therefrom; and
a spoon component, comprising a second longitudinal and hand grippable handle and a spoon head extending distally therefrom;
wherein an end of said first handle of said spatula component is connectable and capable of being disassembled to said second handle of said spoon component so that when connected said spatula head and said spoon head oppose one another and said utensil forms a tong-like configuration and when disassembled each of said components is a separate utensil.

2. A kitchen utensil as claimed in claim 1, wherein said spatula head of said spatula component is substantially flat with a beveled edge.

3. A kitchen utensil as claimed in claim 2, wherein said spatula head further comprises a concave, spoon-like section.

4. A kitchen utensil as claimed in claim 3, wherein said spoon-like section further comprises one or more drainage slots.

5. A kitchen utensil as claimed in claim 1, wherein one or more edges of said spatula head of said spatula component comprises a serrated cutting edge.

6. A kitchen utensil as claimed in claim 1, wherein said spoon head of said spoon component comprises a spoon shaped distal end with a leading beveled tip.

7. A kitchen utensil as claimed in claim 6, wherein said spoon head is formed of a first partial spoon section formed of the same material as said handle and comprises a smooth transition from said longitudinal handle into said partial spoon section of said spoon head and the distal end of said spoon head comprises a silicone component forming a second partial spoon section and said first and second partial spoon sections integrate and comprise the complete and smooth shape of said spoon head.

8. A kitchen utensil as claimed in claim 7, wherein said silicone component has a substantially flat, from side to side but beveled outer edge.

9. A kitchen utensil as claimed in claim 1, wherein said handle of said spoon component is secured to said handle of said spatula component at a hinged connecting point.

10. A kitchen utensil as claimed in claim 9, wherein said connecting point is located along said longitudinal handles of said components and near to the proximal ends thereof.

11. A kitchen utensil as claimed in claim 9, wherein said connecting point comprises a spring to outwardly bias said handles away from one another.

12. A kitchen utensil as claimed in claim 9 wherein the handles are formed of a resilient material and the compression of said handles at said connecting point is against a tendency of said handles to separate as a consequence of said resiliency.

13. A kitchen utensil as claimed in claim 10, further comprising a spring located adjacent to said connecting point, said spring configured to force said spoon component apart from said spatula component when no force is applied forcing the two handles towards one another.

14. A kitchen utensil as claimed in claim 13, wherein said spatula component and said spoon component at said connecting point is formed of a resilient material.

15. A kitchen utensil as claimed in claim 9 wherein said connecting point comprises a slot and a connecting piece for each of said handles with said slot of a first handle receiving the connecting piece of said second handle and said slot of said second handle receiving the connecting piece of said first handle.

16. A kitchen utensil as claimed in claim 9 wherein said slots and said connecting pieces are formed across the longitudinal axis of said handles and said slots and said connecting pieces each extend about ½ of the width of said handles.
